(19) United States
(12) Patent Application Publication
(10) Pub. No.: US 2025/0200594 A1
(43) Pub. Date: Jun. 19, 2025

(54) METHOD TO DETECT, MAP, LEARN AND PREDICT CANCELLED RIDE-HAILING RIDES

(71) Applicant: HERE GLOBAL B.V., EINDHOVEN (NL)

(72) Inventor: JEROME BEAUREPAIRE, NANTES (FR)

(73) Assignee: HERE GLOBAL B.V., EINDHOVEN (NL)

(21) Appl. No.: 18/544,487

(22) Filed: Dec. 19, 2023

(51) Int. Cl. G06Q 30/0202; G06Q 10/02; G06Q 30/0201; G06Q 50/40

(52) U.S. Cl. CPC G06Q 30/0202; G06Q 10/02; G06Q 30/0206; G06Q 50/40

(57) ABSTRACT

A system to predict cancelled ride-hailing rides is disclosed. The system is configured for detecting, from a mobile application, one or more instances of cancelled ride-hailing rides based on contextual elements related to the cancelled ride-hailing rides; mapping the one or more instances of cancelled ride-hailing rides into one or more generalizable feature vectors; generating a trained machine learning model based on a training feature dataset, where the training feature dataset is an aggregation of the one or more generalizable feature vectors; and predicting, using the trained machine learning model, a likelihood of cancelled ride-hailing rides to take place in a specific time and a specific space partition.

### TECHNOLOGICAL FIELD

An example aspect of the present disclosure generally relates to route planning for users and drivers of ride-hailing vehicles, and more particularly, but without limitation relates to a system, a method, and a computer program product to predict cancelled ride-hailing rides in certain areas and contexts.

### BACKGROUND

Ride-hailing services, such as Uber, Lyft and other ride-on-demand shared driving services provide convenience and flexibility for both riders and drivers. A user may summon a ride-hailing vehicle with an app on a smart device and a vehicle may show up in a matter of minutes. Or, it may not show up at all if the assigned driver cancels the ride. On the other hand, ride-hailing service drivers may take the assigned fare, but the user may cancel unexpectedly, leaving the driver without a passenger and lost money for the time wasted. For various reasons, whether due to the area of pick up/drop off, weather, availability of public transportation or safety reasons, rides are cancelled with some frequency. A system to detect the locations or road links where users or drivers are more likely to cancel their ride-hailing rides may be leveraged to increase consumer experiences and driver profitability.

### BRIEF SUMMARY

The present disclosure provides a system, a method and a computer program product to predict cancelled ride-hailing rides, in accordance with various aspects.

Aspects of the disclosure provide a system to predict cancelled ride-hailing rides. The system includes at least one memory configured to store computer executable instructions; and at least one processor configured to execute the computer executable instructions to: detect, from a mobile application, one or more instances of cancelled ride-hailing rides based on contextual elements related to the cancelled ride-hailing rides; map the one or more instances of cancelled ride-hailing rides into one or more generalizable feature vectors; generate a trained machine learning model based on a training feature dataset, where the training feature dataset is an aggregation of the one or more generalizable feature vectors; and predict, using the trained machine learning model, a likelihood of cancelled ride-hailing rides to take place in a specific time and a specific space partition.

Aspects of the disclosure provide a computer-implemented method to predict cancelled ride-hailing rides. The method includes detecting, from a mobile application, one or more instances of cancelled ride-hailing rides based on contextual elements related to the cancelled ride-hailing rides; mapping the one or more instances of cancelled ride-hailing rides into one or more generalizable feature vectors; generating a trained machine learning model based on a training feature dataset, where the training feature dataset is an aggregation of the one or more generalizable feature vectors; and predicting, using the trained machine learning model, a likelihood of cancelled ride-hailing rides to take place in a specific time and a specific space partition.

Aspects of the disclosure provide a computer program product. The computer program product may include a non-transitory computer readable medium having stored thereon computer executable instructions, which when executed by one or more processors, cause the one or more processors to carry out operations to o predict cancelled ride-hailing rides, the operations comprising: detecting, from a mobile application, one or more instances of cancelled ride-hailing rides based on contextual elements related to the cancelled ride-hailing rides; mapping the one or more instances of cancelled ride-hailing rides into one or more generalizable feature vectors; generating a trained machine learning model based on a training feature dataset, where the training feature dataset is an aggregation of the one or more generalizable feature vectors; and predicting, using the trained machine learning model, a likelihood of cancelled ride-hailing rides to take place in a specific time and a specific space partition.

The foregoing summary is illustrative only and is not intended to be in any way limiting. In addition to the illustrative aspects, aspects, and features described above, further aspects, aspects, and features will become apparent by reference to the drawings and the following detailed description.

### BRIEF DESCRIPTION OF THE DRAWINGS

Having thus described certain aspects of the disclosure in general terms, reference will now be made to the accompanying drawings, which are not necessarily drawn to scale, and wherein:

FIG. 1 illustrates a schematic diagram of a network environment 100 of a system 102 for predicting cancelled ride-hailing rides in accordance with an example aspect;

FIG. 2 illustrates a block diagram of the system for predicting cancelled ride-hailing rides, in accordance with an example aspect;

FIG. 3 illustrates an example the map or geographic database for use by the system for predicting cancelled ride-hailing rides, in accordance with an example aspect; and

FIG. 4 illustrates a flowchart 400 for acts taken in an exemplary method for predicting cancelled ride-hailing rides, in accordance with an aspect.

### DETAILED DESCRIPTION

Some aspects of the present disclosure will now be described more fully hereinafter with reference to the accompanying drawings, in which some, but not all, aspects are shown. Indeed, various aspects may be embodied in many different forms and should not be construed as limited to the aspects set forth herein; rather, these aspects are provided so that this disclosure will satisfy applicable legal requirements. Like reference numerals refer to like elements throughout. As used herein, the terms “data.” “content,” “information,” and similar terms may be used interchangeably to refer to data capable of being transmitted, received and/or stored in accordance with aspects of the present disclosure. Thus, use of any such terms should not be taken to limit the spirit and scope of aspects of the present disclosure.

For purposes of this disclosure, though not limiting or exhaustive, “vehicle” refers to standard gasoline powered vehicles, hybrid vehicles, an electric vehicle, a fuel cell vehicle, and/or any other mobility implement type of vehicle (e.g., bikes, scooters, etc.). The vehicle includes parts related to mobility, such as a powertrain with an engine, a transmission, a suspension, a driveshaft, and/or wheels, etc. The vehicle may be a non-autonomous vehicle or an autonomous vehicle. The term autonomous vehicle (AV) may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) and driving commands or navigation commands. In one aspect, the vehicle may be assigned with an autonomous level. An autonomous level of a vehicle can be a Level 0 autonomous level that corresponds to a negligible automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle.

Users of ride hailing services often need to cancel their rides after they have ordered it. This might happen for example for one of the following reasons:

waiting time is too high;

other options to travel become available (e.g., a delayed bus finally arrives);

the ride was ordered by mistake;

after checking, the user does not like the ride/route details;

the user changed her/his mind on the destination or time to get there, etc.

Similarly, drivers might also have to cancel a booked ride they originally accepted:

because they did not want to refuse the proposed ride which would make their rating go down;

because they are too far from the user(s);

because the trip is not worth it;

because the pick-up area is not safe, etc.

Generally, getting more information about the context and reason why such events happen can be quite insightful as this is the only way to be able to do something about the problem. More specifically, for a user experience purpose: ride-hailing passengers generally do not expect to have their rides cancelled, so facing such situation could be very surprising to them and hence cause some frustration with the service provider.

For the optimization of the drivers' journeys, understanding in which contexts there are more cancellations made by users can allow drivers to wisely chose in which areas they will go and look for potential customers, with a limited risk of cancellations.

Therefore, there is a need to better understand when and where such events occur, what leads to such situations and whether something can be done to limit such occurrences.

Aspects of the disclosure may include building a machine learning (ML) model that is able to predict the likelihood of the events of “users/drivers cancelling their ride-hailing rides” to occur on any given link at any given time.

The disclosed system includes multiple aspects steps to predict cancelled ride-hailing rides.

In an aspect, the system to predict cancelled ride-hailing rides may detect and collect cancelled ride-hailing rides. The system creates a set of observations from one or more input data sources. The system may collect and store various data sources, how observations are detected and the properties of the resulting observations. In an aspect, these contextual features may include a time of an order for a ride-hailing ride, a start of the order for the ride-haling ride, a location of the order, a location of the pick-up, a location of the drop-off, a duration of time between the order and the cancellation, weather conditions, traffic conditions or public transport disruptions around the user.

Detecting cancelled ride-hailing rides can be done from mobile application of service providers (eg. Uber, Lyft, Taxi) as those events are generally app specific.

In an aspect, the disclosed system may map those cancelled ride-hailing rides events. The system may transform observations into machine-readable and generalizable vectors. The system may create enough context around the observations such that commonalities can be detected by an algorithm later. In an aspect, these generalizable feature vectors may include tuples of a time of occurrence of the one or more instances of cancelled ride-hailing rides; a location of the occurrence of the one or more instances of cancelled ride-hailing rides; and a description of the occurrence of the one or more instances of cancelled ride-hailing rides.

For example, the system may encode time and temporal phenomena, where the concrete timestamp of an observation might be less expressive than translating it into categories like “autumn” or “Saturday night”.

In an aspect, the system may map one or more instances of cancelled ride-hailing rides into one or more generalizable feature vectors. The system may encode the observations in order to mark them on a map, together with their characteristics. The observations may be mapped at the link level and considering the offset on the links. In an aspect, the observations may be aggregated on a different spatial entity.

In an aspect, the system may use a trained machine learning model based on a training feature dataset, where the training feature dataset is an aggregation of the one or more generalizable feature vectors. Once each observation has been translated into a vector format suitable to be used as a feature vector for machine learning, what is still required is the desired output value, and to train a model on the resulting (observation, output) pairs.

The system to predict cancelled ride-hailing rides may generate a training data set through aggregation of the observations. In an aspect, the system may aggregate the one or more generalizable feature vectors by an aggregation of all of the more instances of cancelled ride-hailing rides detected on a particular link of a ride during a particular setting.

For example, the system may detect the number of events to be expected while traversing a link. In that case, the system may aggregate all the occurrences detected on a particular link during a particular setting (i.e., all occurrences having the same vector representation). In an example, two generalizable feature vectors may share the same representation and result in a single entry with a count of “2”. In many situations, additional data may be required to contrast occasions where observations occurred with a baseline of underlying events where no observations were made.

In an aspect, the trained machine learning model may include a standard regression or classification task.

With the inputs described above, the system may learn when and where, are consumers mostly cancelling ride-hailing rides are drivers mostly cancelling ride-hailing rides. The trained machine learning model may also take into account the weather conditions and other contextual elements like traffic or alternative transport options that may be relevant for the analysis.

In an aspect, the system to predict cancelled ride-hailing rides may be able to evaluate the reasons for cancellation, such as consumers mostly cancel ride-hailing rides because: the waiting time is too high; other options to travel become available (e.g, a delayed bus finally arrives); the ride was ordered by mistake; after checking, the user does not like the ride/route details; the user changed her/his mind on the destination or time to get there; an improper GPS signal due to urban canyons (“jumping GPS”) led to incorrect start point; carelessness; the user realizes the driver was faking its GPS position, pretending s/he was at the airport while it was not true; or other reasons.

In an aspect, the system to predict cancelled ride-hailing rides may be able to evaluate the reasons for driver cancellation, such as drivers mostly cancel ride-hailing rides because: they did not want to refuse the proposed ride which would make their rating go down; because they are too far from the user(s); because the trip is not worth it financially; because the pick-up area is not safe; carelessness; or other reasons.

In an aspect, the system may also attempt to find out where such cancelled ride-hailing rides would happen most frequently: is that around specific POIs or POI categories or after specific junctions? For example, airports are special cases which trigger specific behaviors of drivers. In an aspect, the observed cancelled ride-hailing rides may occur on specific days or events.

In an aspect, the system to predict cancelled ride-hailing rides may predict, using the trained machine learning model, a likelihood of cancelled ride-hailing rides to take place in a specific time and a specific space partition. Based on the previous acts taken by the system, the trained machine learning model may then have enough inputs to be able to predict the likelihood of cancelled ride-hailing rides to take place in some specific time and space partition (e.g., on link 1234 between 19:00 and 19:05). The resulting trained machine learning model can be used to predict values for new situations. In an aspect, the disclosed system to predict cancelled ride-hailing rides may use transfer learning. Once a trained machine learning model for one region has been established, transfer learning could be applied to benefit from it in areas where historical information is not available. In an aspect, the system to predict cancelled ride-hailing rides may be used as a baseline until data can be collected in such new area and the model can then be adapted to better match the local behaviors.

In an aspect, the system to predict cancelled ride-hailing rides may allow for mitigation or reduction of cancelled ride-hailing rides. For example, the system may create routes at different times, represent each link and time option as a situation that can be vectorized through the mapping acts and predict the value of interest to a rider or driver for each.

In an aspect, the system could contextually apply the trained machine learning model to mitigate/reduce the number of cancelled rides by both parties. The system may, in an aspect, provide additional confirmation for users to order and accept a ride-hailing ride. The system, may, through a display on a mobile device, inform consumers that cancelled ride-hailing rides are high in the current area/context, so “are you sure you want to order a ride now?” The system, in an aspect, may provide, through a display on a mobile device, additional confirmation for drivers. For example, the system may inform drivers that cancelled ride-hailing rides by drivers are high in the current context, and confirm with a driver “are you sure you want and can take this order now?”

Depending on the main reasons identified as the cause for cancellation, the system may, if the cancellation is due to user error, ask for additional confirmation. If the cancellation is due to too long a waiting time for a ride, the system may make sure this information is clearly visible and accurate on a display of a mobile device before the order is placed.

In an aspect, if the cancellation is due to other options becoming available, a service provider could monitor the public transportation systems (such as buses or trains) to assess the risks of such a cancellation happening. For example, the system may determine that lots of Uber rides were ordered in the last few minutes because a bus line was disrupted. If the bus line is working again, there may be a high probability that many people will cancel their rides.

As a mitigation measure, the system to predict cancelled ride-hailing rides may increase cancellation fees contextually to limit the number of cancellations. In an aspect, the system may mitigate cancelations by blacklisting users/drivers who cancel rides too frequently. Other mitigation measures may be employed as well, based on the generated datasets and observations.

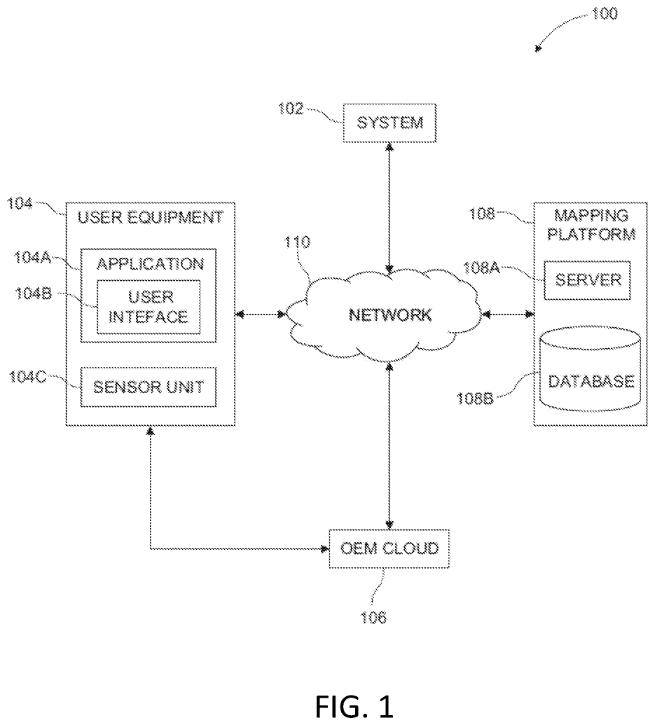

FIG. 1 illustrates a schematic diagram of a network environment 100 of a system 102 predict cancelled ride-hailing rides in accordance with an example aspect. The system 102 may be communicatively coupled with, a user equipment (UE) 104, an OEM cloud 106, a mapping platform 108, via a network 110. The UE 104 may be a vehicle electronics system, onboard automotive electronics/computers, a mobile device such as a smartphone, tablet, smart watch, smart glasses, laptop, wearable device or other UE platforms known to one of skill in the art. The mapping platform 108 may further include a server 108A and a database 108B. The user equipment includes an application 104A, a user interface 104B, and a sensor unit 104C. Further, the server 108A and the database 108B may be communicatively coupled to each other.

The system 102 may comprise suitable logic, circuitry, interfaces and code that may be configured to process the sensor data obtained from the UE 104 for point of interest features or weather conditions in a region, that may be used to assist a user or driver to predict cancelled ride-hailing rides. Such features can also include a vehicle location, a vehicle heading, a timestamp, an impact intensity or a combination thereof.

The system 102 may be communicatively coupled to the UE 104, the OEM cloud 106, and the mapping platform 108 directly via the network 110. Additionally, or alternately, in some example aspects, the system 102 may be communicatively coupled to the UE 104 via the OEM cloud 106 which in turn may be accessible to the system 102 via the network 110.

All the components in the network environment 100 may be coupled directly or indirectly to the network 110. The components described in the network environment 100 may be further broken down into more than one component and/or combined together in any suitable arrangement. Further, one or more components may be rearranged, changed, added, and/or removed. Furthermore, fewer or additional components may be in communication with the system 102, within the scope of this disclosure.

The system 102 may be embodied in one or more of several ways as per the required implementation. For example, the system 102 may be embodied as a cloud-based service or a cloud-based platform. As such, the system 102 may be configured to operate outside the UE 104. However, in some example aspects, the system 102 may be embodied within the UE 104. In each of such aspects, the system 102 may be communicatively coupled to the components shown in FIG. 1 to carry out the desired operations and wherever required modifications may be possible within the scope of the present disclosure.

The UE 104 may be a vehicle electronics system, onboard automotive electronics/computers, a mobile device such as a smartphone, tablet, smart watch, smart glasses, laptop, wearable device and the like that is portable in itself or as a part of another portable/mobile object, such as, a vehicle known to one of skill in the art. The UE 104 may comprise a processor, a memory and a network interface. The processor, the memory and the network interface may be communicatively coupled to each other. In some example aspects, the UE 104 may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to the user. In such example aspects, the UE 104 may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the UE 104. Additional, different, or fewer components may be provided. For example, the UE 104 may be configured to execute and run mobile applications such as a messaging application, a browser application, a navigation application, and the like. In accordance with an aspect, the UE 104 may be directly coupled to the system 102 via the network 110. For example, the UE 104 may be a dedicated vehicle (or a part thereof) for gathering data for development of the map data in the database 108B. In some example aspects, the UE 104 may be coupled to the system 102 via the OEM cloud 106 and the network 110. For example, the UE 104 may be a consumer mobile phone (or a part thereof) and may be a beneficiary of the services provided by the system 102. In some example aspects, the UE 104 may serve the dual purpose of a data gatherer and a beneficiary device. The UE 104 may be configured to provide sensor data to the system 102. In accordance with an aspect, the UE 104 may process the sensor data for information that may be used to predict cancelled ride-hailing rides, such as weather, traffic conditions, community alerts, etc. Further, in accordance with an aspect, the UE 104 may be configured to perform processing related to predict cancelled ride-hailing rides

The UE 104 may include the application 104A with the user interface 104B to access one or more applications. The application 104B may correspond to, but not limited to, map related service application, navigation related service application and location-based service application. In other words, the UE 104 may include the application 104A with the user interface 104B. The user interface 104B may be a dedicated user interface configured to show potential locations or contexts of cancelled ride-hailing rides. The user interface 104B may be in the form of a map depicting regions of high or low risk of cancelled ride-hailing rides, according to aspects of the disclosure.

The sensor unit 104C may be embodied within the UE 104. The sensor unit 104C comprising one or more sensors may capture sensor data, in a certain geographic location. In accordance with an aspect, the sensor unit 104C may be built-in, or embedded into, or within interior of the UE 104. The one or more sensors (or sensors) of the sensor unit 104C may be configured to provide the sensor data comprising location data associated with a location of a user. In accordance with an aspect, the sensor unit 104C may be configured to transmit the sensor data to an Original Equipment Manufacturer (OEM) cloud. Examples of the sensors in the sensor unit 104C may include, but not limited to, a microphone, a camera, an acceleration sensor, a gyroscopic sensor, a LIDAR sensor, a proximity sensor, and a motion sensor.

The sensor data may refer to sensor data collected from a sensor unit 104C in the UE 104. In accordance with an aspect, the sensor data may be collected from a large number of mobile phones. In accordance with an aspect, the sensor data may refer to the point cloud data. The point cloud data may be a collection of data points defined by a given coordinates system. In a 3D coordinates system, for instance, the point cloud data may define the shape of some real or created physical objects. The point cloud data may be used to create 3D meshes and other models used in 3D modelling for various fields. In a 3D Cartesian coordinates system, a point is identified by three coordinates that, taken together, correlate to a precise point in space relative to a point of origin. The LIDAR point cloud data may include point measurements from real-world objects or photos for a point cloud data that may then be translated to a 3D mesh or NURBS or CAD model. In accordance with an aspect, the sensor data may be converted to units and ranges compatible with the system 102, to accurately receive the sensor data at the system 102. Additionally, or alternately, the sensor data of a UE 104 may correspond to movement data associated with a user of the user equipment. Without limitations, this may include motion data, position data, orientation data with respect to a reference and the like.

The mapping platform 108 may comprise suitable logic, circuitry, interfaces and code that may be configured to store map data associated with a geographic area in the region of interest related to raised features on the road, such as, for example, speed bumps, speed humps, speed tables, curbs, etc. The map data may include traffic features and include historical (or static) traffic features such as road layouts, pre-existing road networks, business, educational and recreational locations. POI locations, historical and real-time weather conditions in the region or a combination thereof. The server 108A of the mapping platform 108 may comprise processing means and communication means. For example, the processing means may comprise one or more processors configured to process requests received from the system 102 and/or the UE 104. The processing means may fetch map data from the database 108B and transmit the same to the system 102 and/or the UE 104 in a suitable format. In one or more example aspects, the mapping platform 108 may periodically communicate with the UE 104 via the processing means to update a local cache of the map data stored on the UE 104. Accordingly, in some example aspects, map data may also be stored on the UE 104 and may be updated based on periodic communication with the mapping platform 108.

In an aspect, the map data may include, and the database 108B of the mapping platform 108 may store real-time, dynamic data about road features to predict cancelled ride-hailing rides. For example, real-time data may be collected to predict cancelled ride-hailing rides, such as weather, POI events, traffic information, etc. Other data records may include computer code instructions and/or algorithms for executing a trained machine learning model that is capable of assisting to predict cancelled ride-hailing rides.

The database 108B of the mapping platform 108 may store map data of one or more geographic regions that may correspond to a city, a province, a country or of the entire world. The database 108B may store point cloud data collected from the UE 104. The database 108B may store data such as, but not limited to, node data, road segment data, link data, point of interest (POI) data, link identification information, and heading value records. The database 108B may also store cartographic data, routing data, and/or maneuvering data. According to some example aspects, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities for identifying location of building.

Optionally, the database 108B may contain path segment and node data records, such as shape points or other data that may represent raised features and vehicle speed control indications, links or areas in addition to or instead of the vehicle road record data. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The database 108B may also store data about the POIs and their respective locations in the POI records. The database 108B may additionally store data about places, such as cities, towns, or other communities, and other geographic features such as bodies of water, and mountain ranges. Such place or feature data can be part of the POI data or can be associated with POIs or POI data records (such as a data point used for displaying or representing a position of a city). In addition, the database 108B may include event data (e.g., traffic incidents, construction activities, scheduled events, unscheduled events, accidents, diversions etc.) associated with the POI data records or other records of the database 108B. Optionally or additionally, the database 108B may store 3D building maps data (3D map model of objects) of structures, topography and other visible features surrounding roads and streets, including raised features on the roads.

The database 108B may be a master map database stored in a format that facilitates updating, maintenance, and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by the UE 104. The navigation-related functions may correspond to vehicle navigation, pedestrian navigation, or other types of navigation. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the database 108B may be a master geographic database, but in alternate aspects, the database 108B may be embodied as a client-side map database and may represent a compiled navigation database that may be used in or with end user devices (such as the UE 104) to provide navigation and/or map-related functions. In such a case, the database 108B may be downloaded or stored on the end user devices (such as the UE 104).

The network 110 may comprise suitable logic, circuitry, and interfaces that may be configured to provide a plurality of network ports and a plurality of communication channels for transmission and reception of data, such as the sensor data, map data from the database 108B, etc. Each network port may correspond to a virtual address (or a physical machine address) for transmission and reception of the communication data. For example, the virtual address may be an Internet Protocol Version 4 (IPv4) (or an IPV6 address) and the physical address may be a Media Access Control (MAC) address. The network 110 may be associated with an application layer for implementation of communication protocols based on one or more communication requests from at least one of the one or more communication devices. The communication data may be transmitted or received, via the communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

Examples of the network 110 may include, but is not limited to a wireless channel, a wired channel, a combination of wireless and wired channel thereof. The wireless or wired channel may be associated with a network standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a Long Term Evolution (LTE) networks (for e.g. LTE-Advanced Pro), 5G New Radio networks, ITU-IMT 2020 networks, a plain old telephone service (POTS), and a Metropolitan Area Network (MAN). Additionally, the wired channel may be selected on the basis of bandwidth criteria. For example, an optical fiber channel may be used for a high bandwidth communication. Further, a coaxial cable-based or Ethernet-based communication channel may be used for moderate bandwidth communication.

The system, apparatus, method and computer program product described above may be any of a wide variety of computing devices and may be embodied by either the same or different computing devices. The system, apparatus, etc. may be embodied by a server, a computer workstation, a distributed network of computing devices, a personal computer or any other type of computing device. The system, apparatus, method and computer program product may be configured to determine a driving decision may similarly be embodied by the same or different server, computer workstation, distributed network of computing devices, personal computer, or other type of computing device.

Alternatively, the system, apparatus, method and computer program product may be embodied by a computing device on board a vehicle, such as a computer system of a vehicle, e.g., a computing device of a vehicle that supports safety-critical systems such as the powertrain (engine, transmission, electric drive motors, etc.), steering (e.g., steering assist or steer-by-wire), and/or braking (e.g., brake assist or brake-by-wire), a navigation system of a vehicle, a control system of a vehicle, an electronic control unit of a vehicle, an autonomous vehicle control system (e.g., an autonomous-driving control system) of a vehicle, a mapping system of a vehicle, an Advanced Driver Assistance System (ADAS) of a vehicle), or any other type of computing device carried by the vehicle. Still further, the apparatus may be embodied by a computing device of a driver or passenger on board the vehicle, such as a mobile terminal, e.g., a personal digital assistant (PDA), mobile telephone, smart phone, personal navigation device, smart watch, tablet computer, or any combination of the aforementioned and other types of portable computer devices.

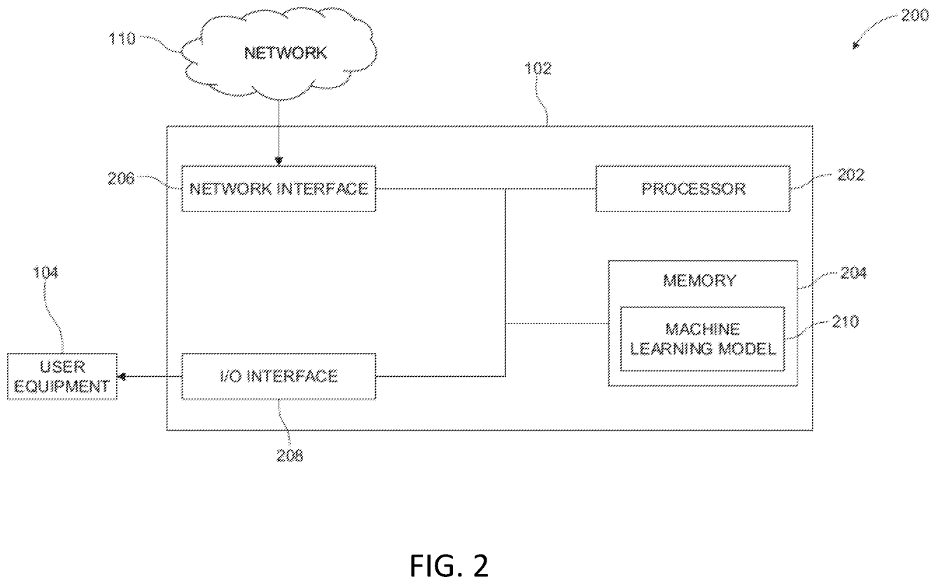

FIG. 2 illustrates a block diagram 200 of the system 102, exemplarily illustrated in FIG. 1, to predict cancelled ride-hailing rides, in accordance with an example aspect. FIG. 2 is described in conjunction with elements from FIG. 1.

As shown in FIG. 2, the system 102 may comprise a processing means such as a processor 202, storage means such as a memory 204, a communication means, such as a network interface 206, an input/output (I/O) interface 208, and a machine learning model 210. The processor 202 may retrieve computer executable instructions that may be stored in the memory 204 for execution of the computer executable instructions. The system 102 may connect to the UE 104 via the I/O interface 208. The processor 202 may be communicatively coupled to the memory 204, the network interface 206, the I/O interface 208, and the machine learning model 210.

The processor 202 may comprise suitable logic, circuitry, and interfaces that may be configured to execute instructions stored in the memory 204. The processor 202 may obtain sensor data associated with cancelled ride-hailing rides. The sensor data may be captured by one or more UE, such as the UE 104. The processor 202 may be configured to determine raised features in the region of navigation, based on the sensor data. The processor 202 may be further configured to determine, using a trained machine learning model in conjunction with ground truth of the region, one or more potential locations of cancelled ride-hailing rides, where the ground truth of a region comprises positive observations of locations where cancelled ride-hailing rides may occur and a likelihood of cancelled ride-hailing rides to take place in a specific time and a specific space partition.

Examples of the processor 202 may be an Application-Specific Integrated Circuit (ASIC) processor, a Complex Instruction Set Computing (CISC) processor, a central processing unit (CPU), an Explicitly Parallel Instruction Computing (EPIC) processor, a Very Long Instruction Word (VLIW) processor, and/or other processors or circuits. The processor 202 may implement a number of processor technologies known in the art such as a machine learning model, a deep learning model, such as a recurrent neural network (RNN), a convolutional neural network (CNN), and a feed-forward neural network, or a Bayesian model. As such, in some aspects, the processor 202 may include one or more processing cores configured to perform independently. A multi-core processor may enable multiprocessing within a single physical package.

Additionally, or alternatively, the processor 202 may include one or more processors configured in tandem via the bus to enable independent execution of instructions, pipelining and/or multithreading. Additionally, or alternatively, the processor 202 may include one or processors capable of processing large volumes of workloads and operations to provide support for big data analysis. However, in some cases, the processor 202 may be a processor specific device (for example, a mobile terminal or a fixed computing device) configured to employ an aspect of the disclosure by further configuration of the processor 202 by instructions for performing the algorithms and/or operations described herein.

In some aspects, the processor 202 may be configured to provide Internet-of-Things (IoT) related capabilities to users of the UE 104 disclosed herein. The IoT related capabilities may in turn be used to provide smart city solutions by providing real time parking updates, big data analysis, and sensor-based data collection for providing navigation and parking recommendation services. The environment may be accessed using the I/O interface 208 of the system 102 disclosed herein.

The memory 204 may comprise suitable logic, circuitry, and interfaces that may be configured to store a machine code and/or instructions executable by the processor 202. The memory 204 may be configured to store information including processor instructions for training the machine learning model. The memory 204 may be used by the processor 202 to store temporary values during execution of processor instructions. The memory 204 may be configured to store different types of data, such as, but not limited to, sensor data from the UE 104. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The network interface 206 may comprise suitable logic, circuitry, and interfaces that may be configured to communicate with the components of the system 102 and other systems and devices in the network environment 100, via the network 110. The network interface 206 may communicate with the UE 104, via the network 110 under the control of the processor 202. In one aspect, the network interface 206 may be configured to communicate with the sensor unit 104C disclosed in the detailed description of FIG. 1. In an alternative aspect, the network interface 206 may be configured to receive the sensor data from the OEM cloud 106 over the network 110 as described in FIG. 1. In some example aspects, the network interface 206 may be configured to receive location information of a user associated with a UE (such as, the UE 104), via the network 110. In accordance with an aspect, a controller of the UE 104 may receive the sensor data from a positioning system (for example: a GPS based positioning system) of the UE 104. The network interface 206 may be implemented by use of known technologies to support wired or wireless communication of the system 102 with the network 110. Components of the network interface 206 may include, but are not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer circuit.

The I/O interface 208 may comprise suitable logic, circuitry, and interfaces that may be configured to operate as an I/O channel/interface between the UE 104 and different operational components of the system 102 or other devices in the network environment 100. The I/O interface 208 may facilitate an I/O device (for example, an I/O console) to receive an input (e.g., sensor data from the UE 104 for a time duration) and present an output to one or more UE (such as, the UE 104) based on the received input. In accordance with an aspect, the I/O interface 208 may obtain the sensor data from the OEM cloud 106 to store in the memory 202. The I/O interface 208 may include various input and output ports to connect various I/O devices that may communicate with different operational components of the system 102. In accordance with an aspect, the I/O interface 208 may be configured to output mitigation and/or confirmation of cancelled ride-hailing rides to a user device, such as, the UE 104 of FIG. 1.

In example aspects, the I/O interface 208 may be configured to provide the data associated with predicting cancelled ride-hailing rides to the database 108A to update the map of a certain geographic region. In accordance with an aspect, a user requesting information in a geographic region may be updated about historical (or static) road features, real-time or historical weather conditions, point-of-interest opening times, etc. Examples of the input devices may include, but are not limited to, a touch screen, a keyboard, a mouse, a joystick, a microphone, and an image-capture device. Examples of the output devices may include, but are not limited to, a display, a speaker, a haptic output device or other sensory output devices.

In accordance with an aspect, the processor 202 may train the machine learning model 210 to predict cancelled ride-hailing rides. In an aspect of the disclosure, the processor 202 may predict, based on the trained machine learning model in conjunction with ground truth of the region, one or more potential locations of cancelled ride-hailing rides and a likelihood of cancelled ride-hailing rides to take place in a specific time and a specific space partition. In an aspect, a weighted linear regression model may be used to predict, based on the trained machine learning model in conjunction with ground truth of the region, one or more potential locations of cancelled ride-hailing rides and a likelihood of cancelled ride-hailing rides to take place in a specific time and a specific space partition. In another aspect, a look-up table for predicting, based on the trained machine learning model in conjunction with ground truth of the region, one or more potential locations of cancelled ride-hailing rides and a likelihood of cancelled ride-hailing rides to take place in a specific time and a specific space partition.

In another aspect, a machine learning model, such as trained machine learning model 210 discussed earlier, may be used to predict cancelled ride-hailing rides in a region. In accordance with an aspect, the trained machine learning model 210 may be trained offline to obtain a classifier model to automatically predict, using a trained machine learning model trained on ground truth of a region, one or more potential locations of cancelled ride-hailing rides and a likelihood of cancelled ride-hailing rides to take place in a specific time and a specific space partition. For the training of the trained machine learning model 210, different feature selection techniques and classification techniques may be used. The system 102 may be configured to obtain the trained machine learning model 210 and the trained machine learning model 210 model may leverage historical information and real-time data to automatically predict, using a trained machine learning model trained on ground truth of a region, one or more potential locations of cancelled ride-hailing rides and a likelihood of cancelled ride-hailing rides to take place in a specific time and a specific space partition. In one aspect, supervised machine learning techniques may be utilized where ground truth data is used to train the model for different scenarios and then in areas where there is not sufficient ground truth data, the trained machine learning model 210 can be used to predict features or results.

In an aspect, the trained machine learning model 210 may be complemented or substituted with a transfer learning model. The transfer learning model may be used when the contextual factors related to cancelled ride-hailing rides, such as a time of an order for a ride-hailing ride, a start of the order for the ride-haling ride, a location of the order, a location of the pick-up, a location of the drop-off, a duration of time between the order and the cancellation, weather conditions, traffic conditions or public transport disruptions around the use are unavailable, sparse, incomplete, corrupted or otherwise unreliable for predicting cancelled ride-hailing rides in a region. The transfer learning model may then use historical time of an order for a ride-hailing ride, a start of the order for the ride-haling ride, a location of the order, a location of the pick-up, a location of the drop-off, a duration of time between the order and the cancellation, weather conditions, traffic conditions or public transport disruptions around the use, for predicting cancelled ride-hailing rides in a new region.

In accordance with an aspect, various data sources may provide the historical and real-time information on cancelled ride-hailing rides, such as aggregation of all of the more instances of cancelled ride-hailing rides detected on a particular link of a ride during a particular setting as an input to the machine learning model 210. Examples of the machine learning model 210 may include, but not limited to, Decision Tree (DT), Random Forest, and Ada Boost. In accordance with an aspect, the memory 204 may include processing instructions for training of the machine learning model 210 with data set that may be real-time (or near real time) data or historical data. In accordance with an aspect, the data may be obtained from one or more service providers.

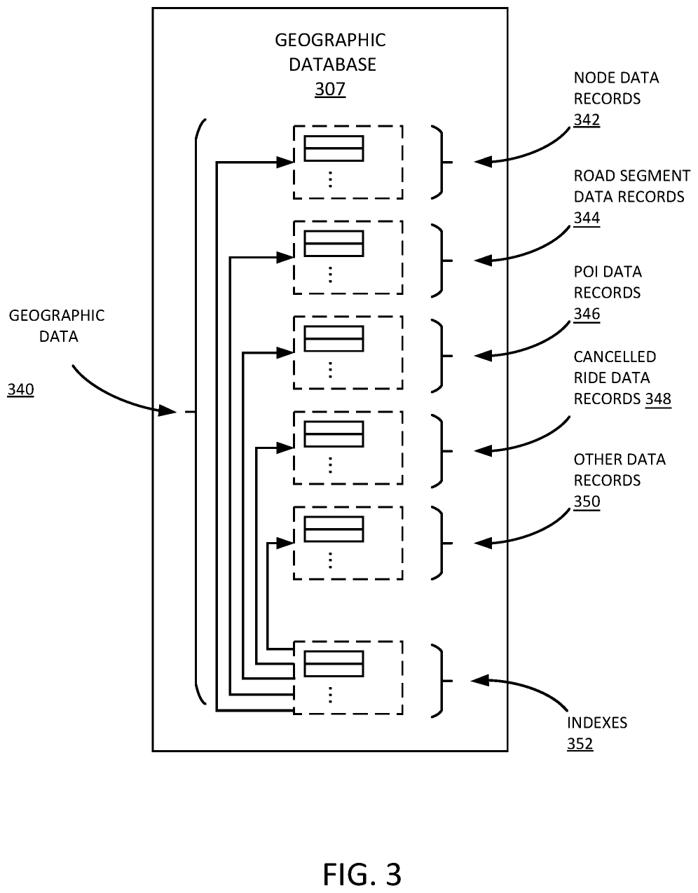

FIG. 3 illustrates an example map or geographic database 307, which may include various types of geographic data 340. The database may be similar to or an example of the database 108B. The data 340 may include but is not limited to node data 342, road segment or link data 344, map object and point of interest (POI) data 346, cancelled ride data records 348, or the like (e.g., other data records 350 such as traffic data, sidewalk data, road dimension data, building dimension data, vehicle dimension/turning radius data, etc.). Other data records may include computer code instructions and/or algorithms for executing a trained machine learning model that is capable of predicting cancelled ride-hailing rides.

A profile of end user mobility graph and personal activity information may be obtained by any functional manner including those detailed in U.S. Pat. Nos. 9,766,625 and 9,514,651, both of which are incorporated herein by reference. This data may be stored in one of more of the databases discussed above including as part of the cancelled ride data records 348 in some aspects. This data may also be stored elsewhere and supplied to the system 102 via any functional means.

In one aspect, the following terminology applies to the representation of geographic features in the database 307. A “Node”—is a point that terminates a link, a “road/line segment”—is a straight line connecting two points, and a “Link” (or “edge”) is a contiguous, non-branching string of one or more road segments terminating in a node at each end. In one aspect, the geographic database 307 follows certain conventions. For example, links do not cross themselves and do not cross each other except at a node. Also, there are no duplicated shape points, nodes, or links. Two links that connect each other have a common node.

The geographic database 307 may also include cartographic data, routing data, and/or maneuvering data as well as indexes 352. According to some example aspects, the road segment data records may be links or segments representing roads, streets, or paths, as may be used in calculating a route or recorded route information for determination of cancelled ride-hailing rides. The node data may be end points (e.g., intersections) corresponding to the respective links or segments of road segment data. The road link data and the node data may represent a road network, such as used by vehicles, cars, trucks, buses, motorcycles, bikes, scooters, and/or other entities.

Optionally, the geographic database 307 may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The geographic database 307 can include data about the POIs and their respective locations in the POI records. The geographic database 307 may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database can include event data (e.g., traffic incidents, construction activities, scheduled events, unscheduled events, etc.) associated with the POI data records or other records of the map database.

The geographic database 107 may be maintained by a content provider e.g., the map data service provider and may be accessed, for example, by the content or service provider processing server. By way of example, the map data service provider can collect geographic data and dynamic data to generate and enhance the map database and dynamic data such as weather- and traffic-related data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that may be available is vehicle data provided by vehicles, such as mobile device, as they travel the roads throughout a region.

The geographic database 307 may be a master map database, such as an HD map database, stored in a format that facilitates updates, maintenance, and development. For example, the master map database or data in the master map database can be in an Oracle spatial format or other spatial format (e.g., accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the geographic database 307 may be a master geographic database, but in alternate aspects, a client-side map database may represent a compiled navigation database that may be used in or with end user devices to provide navigation and/or map-related functions. For example, the map database may be used with the mobile device to provide an end user with navigation features. In such a case, the map database can be downloaded or stored on the end user device which can access the map database through a wireless or wired connection, such as via a processing server and/or a network, for example.

The records for cancelled ride data records 348 may include various points of data such as, but not limited to: time of an order for a ride-hailing ride, a start of the order for the ride-haling ride, a location of the order, a location of the pick-up, a location of the drop-off, a duration of time between the order and the cancellation, weather conditions, traffic conditions or public transport disruptions around the user, etc.

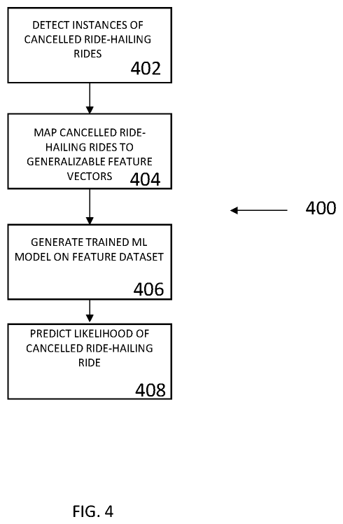

FIG. 4 illustrates a flowchart 400 for acts taken in an exemplary method for predict cancelled ride-hailing rides, in accordance with an aspect. More, fewer or different steps may be provided. FIG. 4 is explained in conjunction with FIG. 1 to FIG. 3. The control starts at act 402.

At act 402, the system 102 may detect, from a mobile application, one or more instances of cancelled ride-hailing rides based on contextual elements related to the cancelled ride-hailing rides. In an aspect, contextual elements may include at least one of the following: a time of an order for a ride-hailing ride, a start of the order for the ride-haling ride, a location of the order, a location of the pick-up, a location of the drop-off, a duration of time between the order and the cancellation, weather conditions, traffic conditions or public transport disruptions around the user, etc.

At act 404, the system 102 may map the one or more instances of cancelled ride-hailing rides into one or more generalizable feature vectors. In an aspect, the one or more generalizable feature vectors comprise tuples of a time of occurrence of the one or more instances of cancelled ride-hailing rides; a location of the occurrence of the one or more instances of cancelled ride-hailing rides; and a description of the occurrence of the one or more instances of cancelled ride-hailing rides.

At act 406, the system 102 may generate a trained machine learning model based on a training feature dataset. In an aspect, the training feature dataset is an aggregation of the one or more generalizable feature vectors. In an aspect, the aggregation of the one or more generalizable feature vectors comprises an aggregation of all of the one or more instances of cancelled ride-hailing rides detected on a particular link of a ride during a particular setting. For example, if one or more instances N of a cancelled ride-hailing ride occur along a link to an event venue during an event, the system 102 may aggregate the generalizable feature vectors to sum up a number N of such occurrences to feed to the trained machine learning model.

At act 408, the system 102 may predict, using the trained machine learning model, a likelihood of cancelled ride-hailing rides to take place in a specific time and a specific space partition. In an aspect, the trained machine learning model may include a transfer learning model for areas where historical information on ride-hailing ride cancellation is unavailable, corrupted or unreliable.

In an aspect, the system 102 may provide mitigation information to a ride-hailing user or a ride-hailing driver. In an aspect, the mitigation information presentation may include at least one of the following: notifying ride-hailing users that cancelled ride-hailing rides by ride-hailing drivers are high in the current area and context; notifying ride-hailing drivers that cancelled ride-hailing rides by ride-hailing drivers are high in the current area and context; increasing cancellation fees contextually to limit ride-hailing ride cancellations; and/or blacklisting ride-hailing users or ride-hailing drivers. In an aspect, the system 102 may present, on a display, areas which have a number of cancelled ride-hailing rides higher than a threshold under a current context of traffic conditions and weather conditions. For an example, if an area is predicted to have a surge of ride-hailing ride cancellations, such as 10-25% above normal for the area and/or context of the setting (e.g., a concert or weather event), the system 102 may present this to a consumer or driver as information of interest. Other mitigation, recommendation, routing or guidance information may be presented as relevant to a consumer seeking to order a ride or a driver offering rides through a mobile application.

The disclosed system 102 may be employed in various applications of use to a user or driver. In an aspect, the system 102 may be employed as a mapping application to show on the map the areas which have many cancelled ride-hailing rides, such as at a particular time of the day or under current context of traffic and weather conditions.

In an aspect, the system 102 may provide routing applications. For example, the system 102 may consider input for the routing algorithm of a consumer leaving a concert hall and which area to go to in order to increase chances to get a ride (and that not be cancelled).

In an aspect, the system 102 may be leveraged to use cancelled ride-hailing ride data with Autonomous Vehicles (A Vs). The A Vs may be interested in knowing where and when they would more likely to see cancelled ride-hailing rides. With this data, the AV may use this as an input into: an AV risk calculation algorithm; an AV routing algorithm; and/or the choice of the areas/districts to travel to.

Blocks of the flowchart 500 support combinations of means for performing the specified functions and combinations of operations for performing the specified functions for performing the specified functions. It will also be understood that one or more blocks of the flowchart 500, and combinations of blocks in the flowchart 500, can be implemented by special purpose hardware-based computer systems which perform the specified functions, or combinations of special purpose hardware and computer instructions.

Alternatively, the system may comprise means for performing each of the operations described above. In this regard, according to an example aspect, examples of means for performing operations may comprise, for example, the processor 202 and/or a device or circuit for executing instructions or executing an algorithm for processing information as described above.

Although the aforesaid description of FIGS. 1-4 is provided with reference to the sensor data, however, it may be understood that the disclosure would work in a similar manner for different types and sets of data as well. The system 102 may generate/train the machine learning model 210 to evaluate different sets of data at various geographic locations. Additionally, or optionally, the determined personalized planning recommendation may be provided to an end user, as an update which may be downloaded from the mapping platform 110. The update may be provided as a run time update or a pushed update.

It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 14 of an apparatus 10 employing an aspect of the present disclosure and executed by the processing circuitry 12. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other aspects of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. Furthermore, in some aspects, additional optional operations may be included. Modifications, additions, or amplifications to the operations above may be performed in any order and in any combination.

Moreover, although the foregoing descriptions and the associated drawings describe example aspects in the context of certain example combinations of elements and/or functions, it should be appreciated that different combinations of elements and/or functions may be provided by alternative aspects without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A computer implemented method to predict cancelled ride-hailing rides, the method comprising:
detecting, from a mobile application, one or more instances of cancelled ride-hailing rides based on contextual elements related to the cancelled ride-hailing rides;
mapping the one or more instances of cancelled ride-hailing rides into one or more generalizable feature vectors;
generating a trained machine learning model based on a training feature dataset, where the training feature dataset is an aggregation of the one or more generalizable feature vectors; and
predicting, using the trained machine learning model, a likelihood of cancelled ride-hailing rides to take place in a specific time and a specific space partition.

2. The method of claim 1, where the contextual elements comprises at least one of the following: a time of an order for a ride-hailing ride, a start of the order for the ride-haling ride, a location of the order, a location of the pick-up, a location of the drop-off, a duration of time between the order and the cancellation, weather conditions, traffic conditions or public transport disruptions around the user.

3. The method of claim 1, where the aggregation of the one or more generalizable feature vectors comprises an aggregation of all of the one or more instances of cancelled ride-hailing rides detected on a particular link of a ride during a particular setting.

4. The method of claim 1, where the trained machine learning model comprises a standard regression model or a classification model.

5. The method of claim 1, where the one or more generalizable feature vectors comprise tuples of a time of occurrence of the one or more instances of cancelled ride-hailing rides; a location of the occurrence of the one or more instances of cancelled ride-hailing rides; and a description of the occurrence of the one or more instances of cancelled ride-hailing rides.

6. The method of claim 1, further comprising providing mitigation information to a ride-hailing user or a ride-hailing driver, where the mitigation information comprises at least one of the following:
notifying ride-hailing users that cancelled ride-hailing rides by ride-hailing drivers are high in the current area and context;
notifying ride-hailing drivers that cancelled ride-hailing rides by ride-hailing drivers are high in the current area and context;
increasing cancellation fees contextually to limit ride-hailing ride cancellations;
and/or blacklisting ride-hailing users or ride-hailing drivers.

7. The method of claim 1, where predicting, using the trained machine learning model, a likelihood of cancelled ride-hailing rides, comprises using a transfer learning model for areas where historical information on ride-hailing ride cancellation is unavailable.

8. A system to predict cancelled ride-hailing rides, comprising:
at least one memory configured to store computer executable instructions; and
at least one processor configured to execute the computer executable instructions to:
detect, from a mobile application, one or more instances of cancelled ride-hailing rides based on contextual elements related to the cancelled ride-hailing rides;
map the one or more instances of cancelled ride-hailing rides into one or more generalizable feature vectors;
generate a trained machine learning model based on a training feature dataset, where the training feature dataset is an aggregation of the one or more generalizable feature vectors; and
predict, using the trained machine learning model, a likelihood of cancelled ride-hailing rides to take place in a specific time and a specific space partition.

9. The system of claim 8, where the contextual elements comprises at least one of the following: a time of an order for a ride-hailing ride, a start of the order for the ride-haling ride, a location of the order, a location of the pick-up, a location of the drop-off, a duration of time between the order and the cancellation, weather conditions, traffic conditions or public transport disruptions around the user.

10. The system of claim 8, where the aggregation of the one or more generalizable feature vectors comprises an aggregation of all of the one or more instances of cancelled ride-hailing rides detected on a particular link of a ride during a particular setting.

11. The system of claim 8, where the trained machine learning model comprises a standard regression model or a classification model.

12. The system of claim 8, where the one or more generalizable feature vectors comprise tuples of a time of occurrence of the one or more instances of cancelled ride-hailing rides; a location of the occurrence of the one or more instances of cancelled ride-hailing rides; and a description of the occurrence of the one or more instances of cancelled ride-hailing rides.

13. The system of claim 8, further comprising computer executable instructions to provide mitigation information to a ride-hailing user or a ride-hailing driver, where the mitigation information comprises at least one of the following:
notifying ride-hailing users that cancelled ride-hailing rides by ride-hailing drivers are high in the current area and context;
notifying ride-hailing drivers that cancelled ride-hailing rides by ride-hailing drivers are high in the current area and context;
increasing cancellation fees contextually to limit ride-hailing ride cancellations; and/or
blacklisting ride-hailing users or ride-hailing drivers.

14. The system of claim 8, where the computer executable instructions to predict, using the trained machine learning model, a likelihood of cancelled ride-hailing rides, comprise computer executable instruction to use a transfer learning model for areas where historical information on ride-hailing ride cancellation is unavailable.

15. The system of claim 8, further comprising a display configured to present areas which have a number of cancelled ride-hailing rides higher than a threshold under a current context of traffic conditions and weather conditions.

16. A computer program product comprising a non-transitory computer readable medium having stored thereon computer executable instructions, which when executed by one or more processors, cause the one or more processors to carry out operations to predict cancelled ride-hailing rides, the operations comprising:
detecting, from a mobile application, one or more instances of cancelled ride-hailing rides based on contextual elements related to the cancelled ride-hailing rides;
mapping the one or more instances of cancelled ride-hailing rides into one or more generalizable feature vectors;
generating a trained machine learning model based on a training feature dataset, where the training feature dataset is an aggregation of the one or more generalizable feature vectors; and
predicting, using the trained machine learning model, a likelihood of cancelled ride-hailing rides to take place in a specific time and a specific space partition.

17. The computer program product of claim 16, where the contextual elements comprises at least one of the following: a time of an order for a ride-hailing ride, a start of the order for the ride-haling ride, a location of the order, a location of the pick-up, a location of the drop-off, a duration of time between the order and the cancellation, weather conditions, traffic conditions or public transport disruptions around the user.

18. The computer program product of claim 16, where the aggregation of the one or more generalizable feature vectors comprises an aggregation of all of the one or more instances of cancelled ride-hailing rides detected on a particular link of a ride during a particular setting.

19. The computer program product of claim 16, where the trained machine learning model comprises a standard regression model or a classification model.

20. The computer program product of claim 16, where the one or more generalizable feature vectors comprise tuples of a time of occurrence of the one or more instances of cancelled ride-hailing rides; a location of the occurrence of the one or more instances of cancelled ride-hailing rides; and a description of the occurrence of the one or more instances of cancelled ride-hailing rides.
